(19) United States
(12) Patent Application Publication
(10) Pub. No.: US 2023/0344894 A1
(43) Pub. Date: Oct. 26, 2023

(54) PACKET BASED IN-LINE PROCESSING FOR DATA CENTER ENVIRONMENTS

(71) Applicant: Intel Corporation, Santa Clara, CA (US)

(72) Inventors: Susanne M. BALLE, Hudson, NH (US); Shihwei CHIEN, Zhubei (TW); Andrzej KURIATA, Gdansk (PL); Nagabhushan CHITLUR, Portland, OR (US)

(21) Appl. No.: 18/216,524

(22) Filed: Jun. 29, 2023

(51) Int. Cl. H04L 67/025

(52) U.S. Cl. CPC H04L 67/025

(57) ABSTRACT

An apparatus is described. The apparatus includes a host side interface to couple to one or more central processing units (CPUs) that support multiple microservice endpoints. The apparatus includes a network interface to receive from a network a packet having multiple frames that belong to different streams, the multiple frames formatted according to a text transfer protocol. The apparatus includes circuitry to: process the frames according to the text transfer protocol and build content of a microservice functional call embedded within a message that one of the frames transports; and, execute the microservice function call.

### BACKGROUND OF THE INVENTION

As data center computing environments strive to increase the amount of inbound request traffic that a data center can respond to, system managers are increasingly focused on efficiently delivering the inbound request traffic to its respective destination(s) within the data center.

### BRIEF DESCRIPTION OF THE DRAWINGS

FIGS. 1a and 1b pertain to a HTTP/2 implementation;

FIGS. 2a, 2b, 2c, 2d, 2e, 2f, 2g, 2h and 2i pertain to an improved HTTP/2 reception process;

FIG. 3 depicts a data center implementation;

FIGS. 4a and 4b depict an infrastructure processing unit (IPU);

FIGS. 5a and 5b depict improved data center implementations.

### DETAILED DESCRIPTION

HTTP/2 is a communication protocol that supports multiple, separate “request/response” sessions (“streams”) over a same network connection (e.g., a Layer 4 Transmission Control Protocol (TCP) connection) between two endpoints.

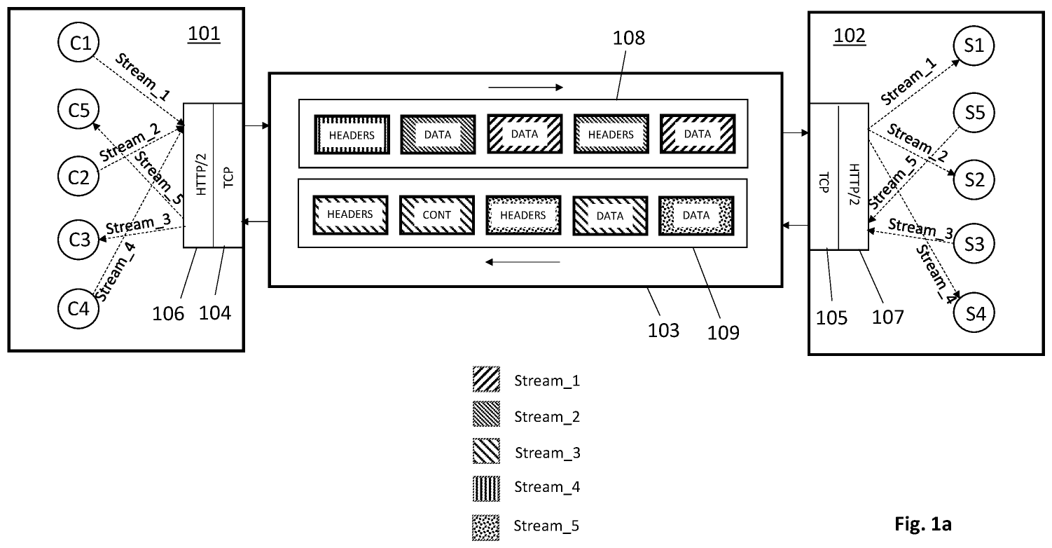

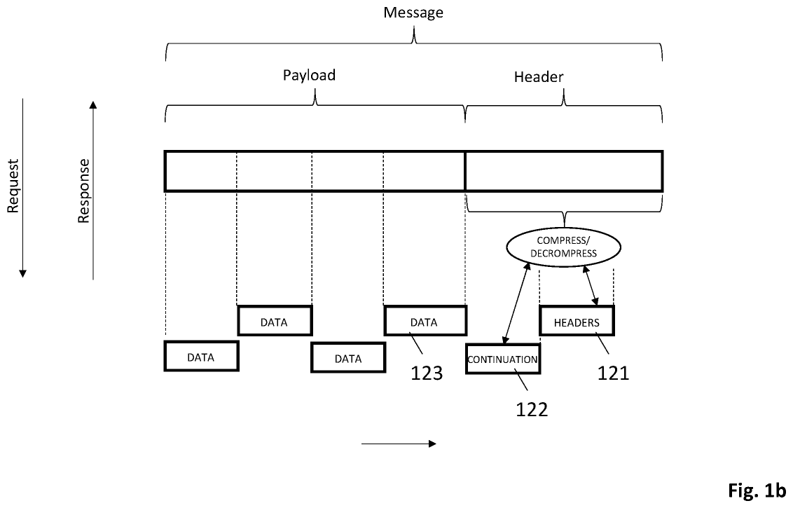

Referring to FIG. 1a, a client device 101 and a data center 102 have established a TCP connection 103 between them. The client device 101 invokes a particular TCP socket instance 104 that executes on the client hardware to communicate with the data center 102 and, likewise, the data center 102 invokes a particular TCP socket instance 105 that executes on data center hardware to communicate with the client device 101. The TCP instances 104, 105 execute the protocol actions that are specific to TCP upon the packets that are sent over connection 103. TCP is expected to guarantee delivery of packets on a receiving end in the same order they were transmitted on the transmitting end without loss of information while in transit.

An HTTP/2 instance 106 is located between the client's TCP socket 104 and the client applications C1-C5. Likewise, on the data center side, a corresponding HTTP/2 instance 107 is located between the data center's TCP socket 105 and the data center services S1-S5 that the client side applications C1-C5 are engaged with. The HTTP/2 instances 106, 107 execute the specific protocol actions that are specific to HTTP/2 upon the packets that are sent over connection 103.

The HTTP/2 instances 106, 107 present respective application program interfaces (APIs) to the applications (Cx) and services (Sx). The applications/services pass outbound header and payload content through the APIs. In response, the HTTP/2 instances 106, 107 form a respective outbound message that is submitted to its corresponding TCP instance for transmission over the connection 103. Likewise, in the receive direction, the TCP instances 104, 105 pass HTTP/2 messages to their corresponding HTTP/2 instances 106, 107. The HTTP/2 instances 106, 107 extract the header and payload content from the messages and pass them to their corresponding application/service.

A request message from any client application (e.g., C1) typically includes a specific command (e.g., “GET”) that the client application C1, through the request message, asks a data center service (e.g., S1) to perform. Upon receipt of the message, the data center service S1 performs the action specified by the command. The performance of the action by the data center service S1 typically generates a response (e.g., a specific item of data that the client application C1 asked the service S1 to GET). The data center service S1 then sends the response to the requesting client application C1.

The header of a request message typically includes the requested action (e.g., GET, PUT) along with other information that pertains to the message (e.g., the target of the message, a timestamp, the size of the message and/or payload, etc.), while, the payload of the request message typically includes an operand pertaining to the requested action (e.g., an address or other information that identifies the information that is to be retrieved in response to a GET request, the data to be PUT on a server, etc.).

The header of a response message typically includes information that identifies the message as a response message (e.g., POST) along with other information that pertains to the message (e.g., the target of the message, a timestamp, the size of the message and/or payload, etc.), while the payload of a response message typically includes the information that was requested in an earlier request message (e.g., the data requested by an earlier GET message).

If the client device 101 is executing different applications C1-C5 that are concurrently engaged with different, respective data center services S1-S5, the HTTP/2 instances 106, 107 allow different logical sessions (“streams”) to concurrently exist over the same TCP connection 103 between the engaged application/service pairs. That is, individual request/response cycles can be carried out between: 1) C1 and S1 (“stream 1”); 2) C2 and S2 (“stream 2”); 3) C3 and S3 (“stream 3”); 4) C4 and S4 (“stream 4”); 5) C5 and S5 (“stream 5”).

In order to enhance the throughput of all streams through the same TCP connection 103, both the client-side and data center-side HTTP/2 instances 106, 107 break down their respective outbound messages into smaller frames.

Referring to FIG. 1b, in the case of an outbound message, an HTTP/2 instance will compress the message's header information and then break down the compressed header information into a leading HEADERS frame 121 and, if the size of the compressed header information exceeds the maximum permissible size of a HEADERS frame 121, one or more additional CONTINUATION frames 122 until all of the compressed header information has been formatted into frames.

Although a lengthy, textual list of information can exist in an HTTP/2 message header, an HTTP/2 instance will compress the list to reduce the size/footprint of the header information for the outbound message.

The HTTP/2 instance also breaks down the message payload into one or more DATA frames 123 until all of the payload has been formatted into frames. The frames are then presented to the HTTP/2 instance's corresponding TCP socket in order (initial HEADERS frame, followed by one or more CONTINUATION frames (if any), followed by one or more DATA frames).

For inbound message, an HTTP/2 instance will perform the reverse of the above described process including the decompression of the header content that was received in the HEADERS 121 frame and any CONTINUATION frames 122.

Notably, if multiple request messages are concurrently generated by the multiple client applications C1-C5, the client-side HTTP/2 instance 106 breaks down the multiple request messages into their constituent frames and then multiplexes the frames into the respective payload of one or more packets that are provided to the TCP instance 104 for transmission over connection 103. Thus, one or more packets are sent over connection 103 whose payload contains respective frames from multiple request messages (multiple streams). FIG. 1a shows an example of such a packet 108 that includes request message frames for each of streams 1, 2 and 4.

Likewise, if multiple response messages are concurrently generated by the data center applications S1-S5, the data center HTTP/2 instance 107 breaks down the multiple response messages into their constituent frames and multiplexes the frames into the respective payload of one or more packets that are sent to the client 101 over the TCP connection 103. Thus, one or more packets are sent over connection 103 whose payload contains respective frames from multiple response messages (multiple streams). FIG. 1a shows an example of such a packet 109 that includes response message frames for both of streams 3 and 5.

A challenge is the reassembling of received frames back to their original message when large numbers of streams are concurrently in flight over the same connection 103 (the HTTP/2 specification recommends a maximum number of streams per connection configuration setting of no less than 100 streams).

In a simplistic approach, in the inbound direction, an HTTP/2 instance will simply queue in memory all received frames for all inbound messages all frames for any particular message have been completely received. After all frames for a message have been received, the message's header content is decompressed. The decompressed header information and message payload are then sent to the application/service that is the target of the message.

Unfortunately, if large numbers of concurrently existing streams are allowed, there can correspondingly be large numbers of messages that are in-flight at any moment in time. In that case, large amounts of memory will be needed to queue all of the frames for all of the messages.

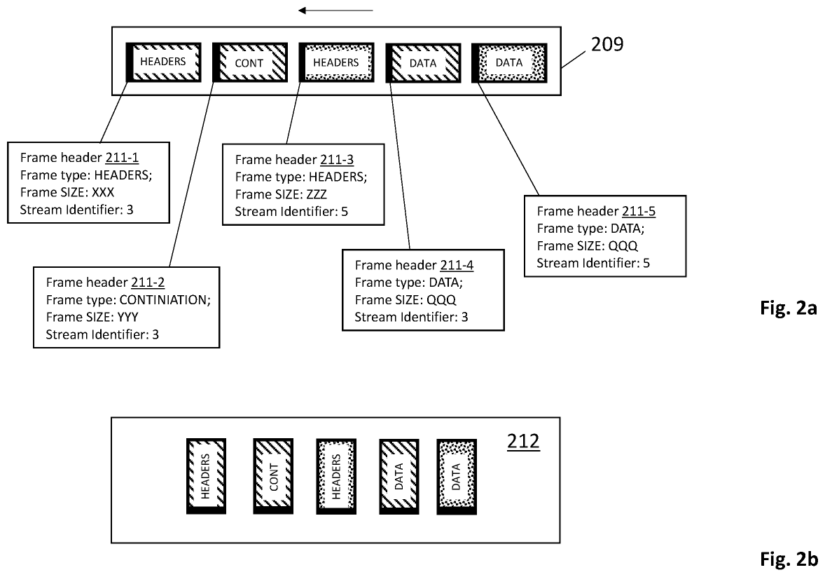

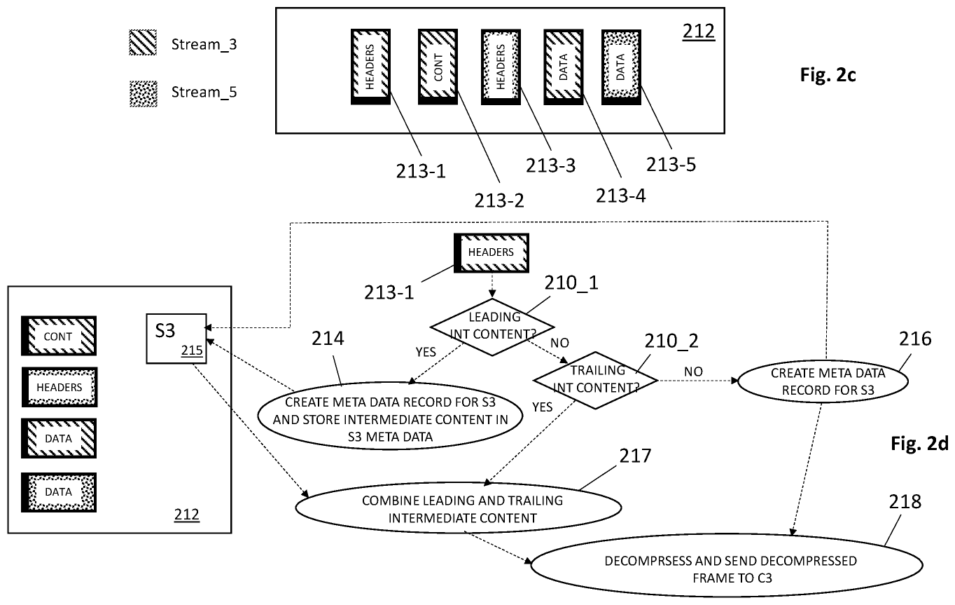

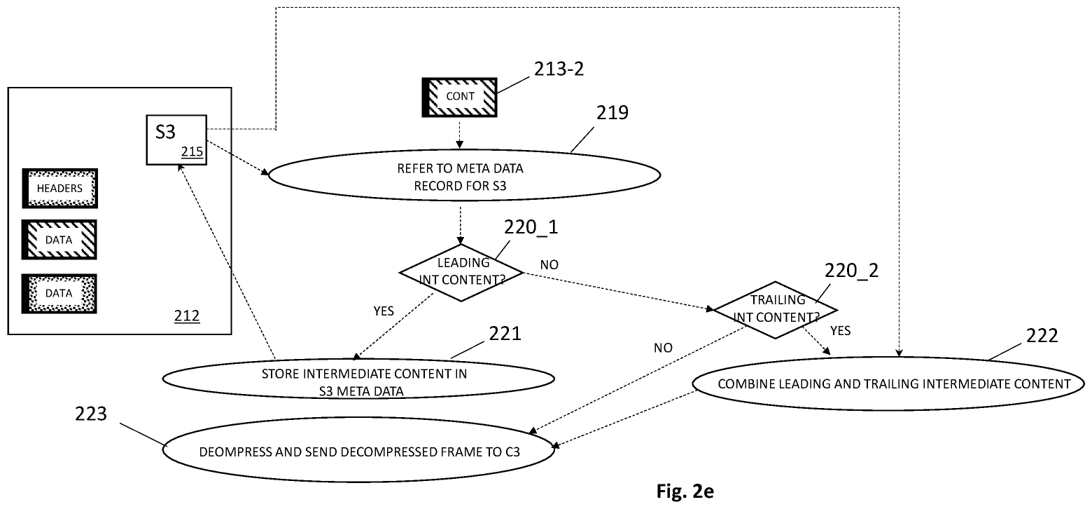

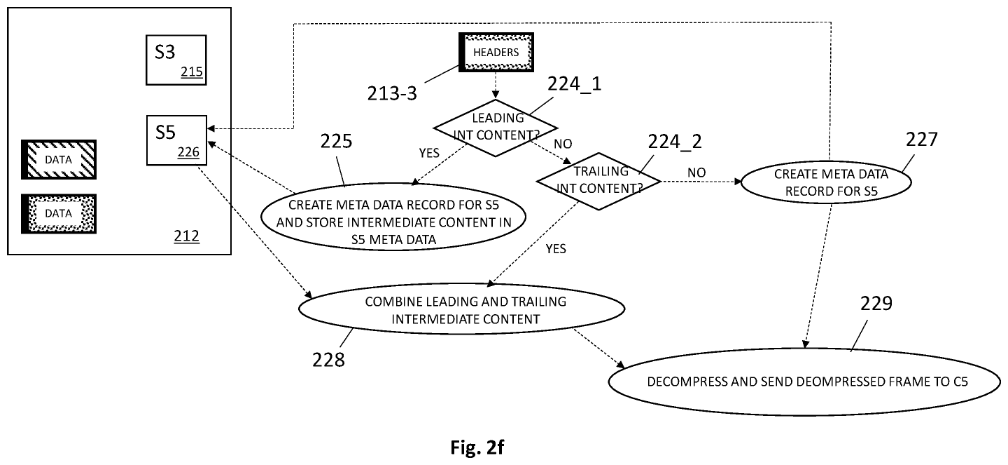

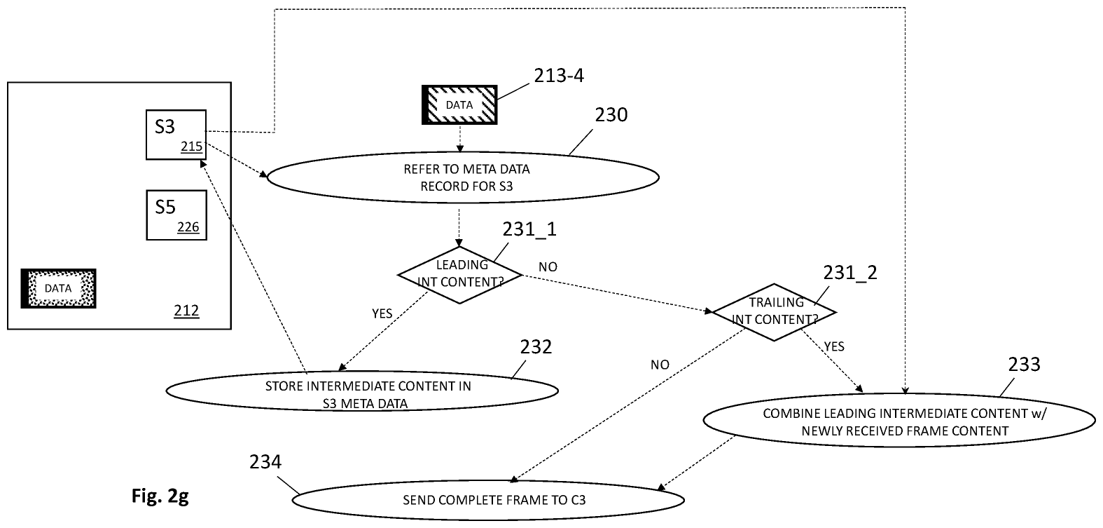

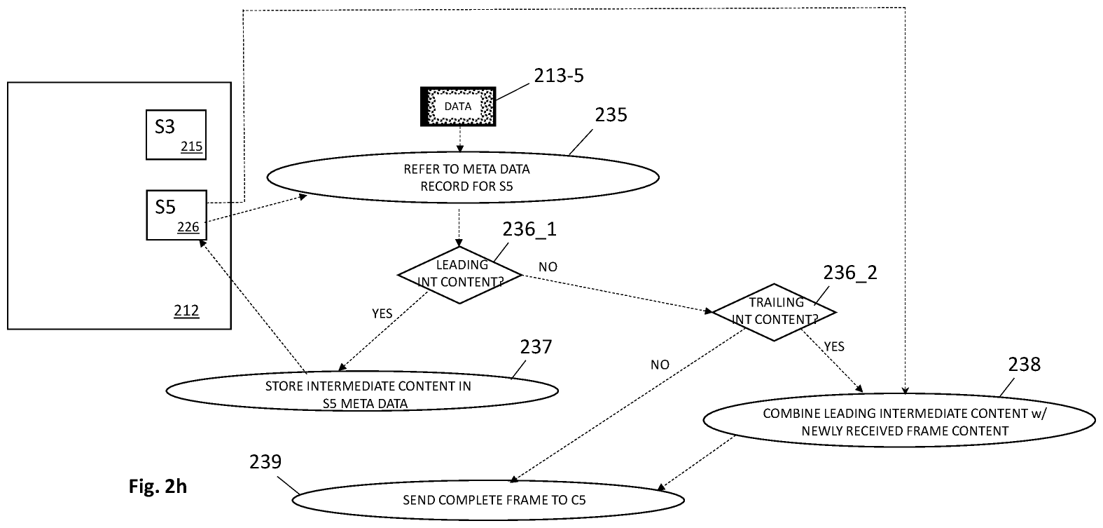

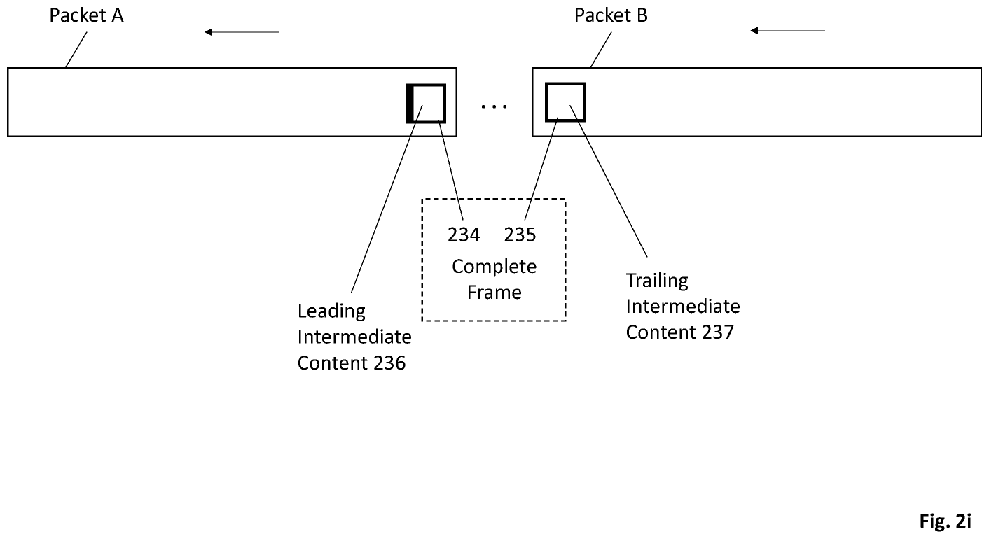

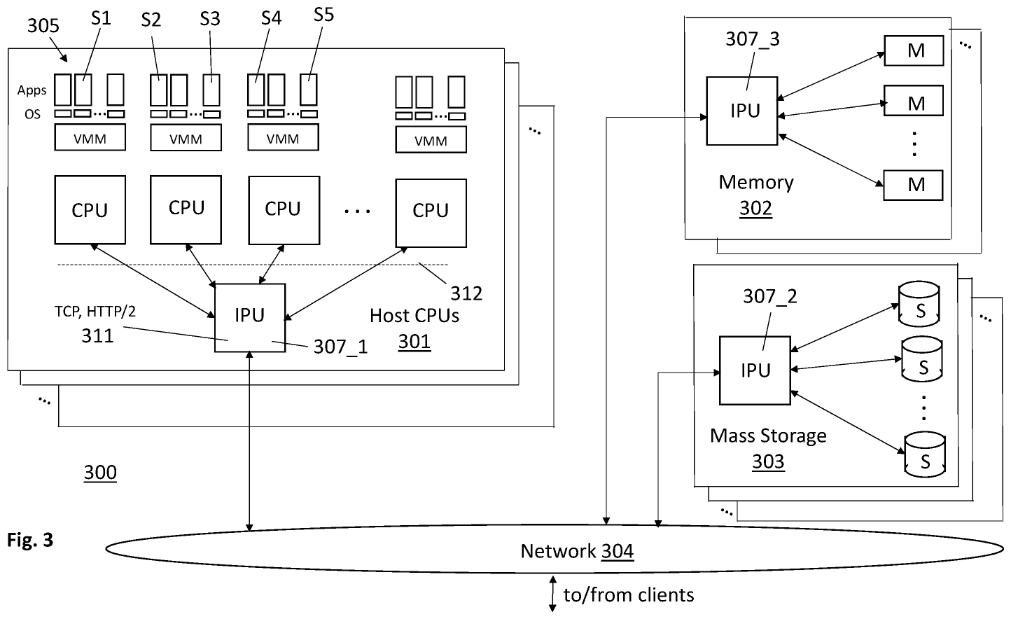

FIGS. 2a through 2i therefore pertain to an improved HTTP/2 instance methodology that processes the inbound frames of in-flight messages as they arrive and then immediately passes their substantive content, if possible, to the targeted application/service.

Here, a targeted application/service expects to receive the substantive content of any inbound message that is directed to it. As such, the targeted/application should be designed with enough memory space to hold, e.g., the complete HTTP/2 message. By passing the payload content of the frames to each targeted application/service, e.g., piecemeal, the targeted application/service is essentially responsible for an inbound message's reassembly from its constituent frames.

Importantly, substantial memory efficiency is achieved because the HTTP/2 instance does not require an amount of memory space necessary to keep all respective inbound frames of all in-flight messages until completion. Instead, such memory space is spread across the memory allocated to the absolute end-points (the targeted application/services).

FIGS. 2a through 2i pertain to an example of the processing performed by client-side HTTP/2 instance 106 upon its receipt of packet 109 of FIG. 1a.

As observed in FIG. 2a, each frame in the inbound packet 209 includes its own respective header information 211 that identifies: 1) type of frame (e.g., HEADERS, CONTINUATION, DATA etc.); 2) the size of the frame; and, 3) the stream that the frame belongs to (“stream identifier”). As such, upon receiving the inbound packet 209, the parser first examines the packet's content and, e.g., based upon the header information found in each frame, breaks the packet payload into its constituent frames and stores them in the HTTP/2 instance's local memory 212 as observed in FIG. 2b.

The HTTP/2 instance then begins to process the series of frames in the same order in which they were arranged in the packet payload (alternatively, frames belonging to a same stream can be batch processed so long as the frames within the same stream are processed in the order in which they were received). Here, referring to FIG. 2c, when the frames 213 were multiplexed into the packet 209 on the transmit end, the transmitting HTTP/2 instance was required to pack the frames 213 in order relative to the message to which they belong. As such, on the receiving end, for any inbound message, the message's frames are received by the receiving HTTP/2 instance in the correct order (here, the lower TCP layer is responsible for delivering packets in the correct order to the HTTP/2 instance).

As such, as observed in FIG. 2c, the HEADERS frame 213-1 for the message that belongs to stream 3 (S3) is followed by a CONTINUATION frame 213-2 for the same S3 message. For the S3 message, the CONTINUATION frame 213-2 is then followed by a DATA frame 213-4. Likewise, the HEADERS frame 213-3 for the message that belongs to stream 5 (S5) is followed by a DATA frame 213-5 that belongs to the same S5 message.

Handling the received frames 213 in order, referring to FIG. 2d, the HTTP/2 instance begins processing the HEADERS frame 213-1 for the S3 message. As described above, a HEADERS frame is used for the first frame of a new message. As such, upon analyzing the header 211-1 of frame 213-1 and recognizing that frame 213-1 is a HEADERS frame type which belongs to stream S3, the HTTP/2 instance will create 216 a new meta data record 215 for the new S3 message and store the meta data record 215, e.g., in the local memory 212 of the HTTP/2 instance. Notably, as described in more detail further below, the answer to each of inquiries 210_1 and 210_2 is “no”.

As described above, the message header content within the payload of a HEADERS frames is compressed and (typically) identifies the intended endpoint target for the message (in the instant example, the intended endpoint for the S3 message is client application C3). As such, the HTTP/2 instance decompresses the payload of the HEADERS frame 213-1 and sends 218 the decompressed frame payload to the C3 endpoint (if the target endpoint is not identified in the payload of the HEADERS frame 213-1, the payload can be locally stored as a form of intermediate content until the target is identified from the processing of a subsequent CONT frame for the S3 message).

As will become more clear in the discussions below, the S3 meta data record 215 can be used for a number of supporting functions used to process the inbound sequence of frames that are carrying the S3 message, such as, monitoring the state of the S3 message's frame reception sequence; handling intermediate frame payload content across packet boundaries (described further below); recording the intended endpoint target for the S3 message, etc. Here, with the HTTP/2 instance processing the payload of the HEADERS frame 213-1 which carries header information for the S3 message, the HTTP/2 instance can glean pertinent information about the S3 message which can be used, e.g., to monitor the state of the S3 message's frame reception sequence (e.g., the size of the S3 message header, the size of the S3 message payload, the size of the S3 message, etc.). For instance, based on the size of the S3 message header, the HTTP/2 instance can determine when the S3 message header has been fully received.

In the specific example of the packet 212 of FIG. 2c, all of the frames 213 in the packet 212 are complete frames. As a consequence, none of the frames 213 have intermediate content. Here, as described in more detail further below, it is possible that a complete frame is divided into a leading portion and trailing portion, where the leading portion is carried by a first packet and the trailing portion is carried by a second, following packet. Such portions are referred to as intermediate content (e.g., leading intermediate content and trailing intermediate content).

For the sake of initial explanation, there is no intermediate content is any of the frames 213 in the packet 212 of FIG. 2c (all of the frames 213 in packet 212 are complete frames). Thus, the initial discussions of FIGS. 2d through 2h are directed to the processing of complete frames 213. Notably, however, the processing flows depicted in FIGS. 2d through 2h include processes that pertain to the existence of intermediate content. Because none of the frames 213 within packet 212 contain intermediate content, the answer to any flow inquiry 210 (FIG. 2d), 220 (FIG. 2e), 224 (FIG. 2f), 231 (FIG. 2g), and 236 (FIG. 2h) will be “no” during the initial discussion of each of FIGS. 2d through 2h. Following the initial discussion of FIGS. 2d through 2h, which completes the discussion of the processing of the frames 213 within packet 212, the subject of intermediate content and the relevance of the intermediate content flows 210, 220, 224, 231 and 236 is discussed in reference to FIG. 2i.

Referring to FIG. 2e, after the first frame 213-1 within packet 212 has been processed, the HTTP/2 instance then proceeds to process the next frame in the packet 212 which is a CONT frame 213-2 for the same S3 message as the HEADERS frame 213-1 that was just processed. After processing the header information 211-2 of frame 213-2, the HTTP/2 instance refers 219 to the meta data 215 that has already been created for message S3. Here, the meta data can at least identify the endpoint target for the S3 message (assuming it was contained in the payload of the earlier HEADERS frame 213-1 and recorded in the S3 meta data 215).

With the answer to intermediate content inquiries 220 being “no”, the HTTP/2 instance decompresses the payload of the CONT frame 213-2 and sends 223 to the C3 endpoint. As a follow-up procedure to the look-up 219 into the S3 meta data 215, the HTPP/2 instance can update (“write-back”) the meta data 215 to include progress information on the processing of the S3 message. For instance, the S3 meta data 215 can be updated to indicate that a first CONT frame has just been received for the S3 message, that a first DATA frame is next expected for the S3 message (e.g., based on the message header size and the size of the respective payloads of frames 213-1, 213-2, etc.).

Referring to FIG. 2f, the HTTP/2 instance next proceeds to process frame 213-3 which is a HEADERS frame for a message that belongs to stream S5. Because the HEADERS frame 213-3 marks the beginning of a new message, the HTTP/2 instance repeats the process of FIG. 2d but where new meta data record 227 is created 225 for new message S5, and the payload of frame 213-3 is decompressed and sent 229 to client application C5.

Referring to FIG. 2g, the HTTP-2 instance next proceeds to process frame 213-4 which is the first DATA frame for the S3 message (the payload of the S3 message is now being processed). The HTTP-2 instance refers 230 to the meta data 215 for the S3 message to, e.g., understand the size of the data payload and/or the overall size of the S3 message. Here, e.g., if the meta data 215 includes the size of the header, the size of the payload and/or the size of the overall S3 message, the meta data can be used by the HTTP instance to track how many frames have already arrived for the S3 message, and/or, how many more DATA frames are expected for the S3 message.

With the answer to inquiries 231_1, 231_2 being “no”, the HTTP/2 instance sends 234 the complete frame with S3 message payload data to C3. Moreover, as a follow-up procedure to the look-up 230 into the S3 meta data 215, the HTPP/2 instance can update the meta data 215 to include progress information on the processing of the S3 message. For instance, the S3 meta data 215 can be updated to indicate that a first DATA frame has just been received for the S3 message, how many more DATA frames are next expected for the S3 message (e.g., based on the message size and/or message payload size and the content of the respective payloads of frames 213-1, 213-2 which contained the S3 message's header information).

Referring to FIG. 2h, the HTTP-2 instance next proceeds to process frame 213-5 which is the first DATA frame for the S5 message (the payload of the S5 message is now being processed). The HTTP-2 instance refers 235 to the meta data 226 for the S5 message to, e.g., understand the size of the data payload and/or the overall size of the S5 message. Here, e.g., if the meta data 226 includes the size of the header, the size of the payload and/or the size of the overall S5 message, the meta data can be used by the HTTP instance to track how many frames have already arrived for the S5 message, and/or, how many more DATA frames are expected for the S5 message.

With the answer to inquiries 236_1, 236_2 being “no”, the HTTP/2 instance sends 239 the complete frame with S5 message payload data to C5. Moreover, as a follow-up procedure to the look-up 235 into the S5 meta data 226, the HTPP/2 instance can update the meta data 226 to include progress information on the processing of the S5 message. For instance, the S5 meta data 226 can be updated to indicate that a first DATA frame has just been received for the S5 message, how many more DATA frames are next expected for the S5 message (e.g., based on the message size and/or message payload size).

FIG. 2i pertains to the particular circumstance of intermediate data that results from, on the transmit side, a frame being divided into different portions 234, 235 that are placed into different packets (Packet A, Packet B) and sent over the network. Here, as observed in FIG. 2a a first “leading” portion of a frame 234 is placed into Packet A and a second “trailing” portion of a frame 235 is placed into Packet B, where Packet B follows Packet A in the flow of packets that are sent for the stream that the frame 234, 235 belongs to. Notably, Packet A and Packet B need not be consecutive packets in the flow. Conceivably, one or more packets that contain the frames of other streams that are multiplexed with the stream that frame 234, 235 belongs to can be inserted between Packet A and Packet B.

Regardless, as observed in FIG. 2i, the payload 236 of the first portion 234 of the divided frame corresponds to “leading” intermediate content 236 of the message that the frame is carrying, whereas the payload 237 of the second portion 235 of the divided frame corresponds to “trailing” intermediate content 237 of the message that the complete frame is carrying. For example, if the complete frame 234, 235 is a HEADERS frame or CONT frame, content 236 corresponds to a preceding portion of the header content of the message that the complete frame 234, 235 is carrying and content 237 corresponds to a following/trailing portion of the header content (the trailing content 237 includes at least some of the frame header content of the leading portion, such as stream ID, so the frame that the trailing content 237 belongs to can be identified).

When a frame is divided and intermediate content is created as a result, the answer to one of the intermediate content inquiries described above becomes “yes”. Which inquiry becomes “yes” depends on whether leading or trailing content was received in the newly received frame portion.

Thus, referring back to FIG. 2d, if HEADERS frame 213-1 is a leading portion 234, the answer to inquiry 210_1 is “yes” and the leading intermediate content carried by the frame 213-1 is stored into local memory 212 along with the meta data 215 that is newly created 214 for the S3 message. By contrast, if HEADERS frame 213-1 is a trailing portion 235, the answer to inquiry 210_1 is “no” but the answer to inquiry 210_2 is “yes”. As such, the meta data record 215 has already been created (from the preceding processing of the leading portion) and stores the leading portion. The leading portion is therefore read from local memory 212 and combined 217 with the newly received trailing portion. The combined content (which corresponds to a compressed complete HEADERS frame payload) is then decompressed and sent to C3.

With respect to FIG. 2e, if CONT frame 213-2 is a leading portion 234, the answer to inquiry 220_1 is “yes”. As such the intermediate leading payload content 236 is stored 221 in the meta data 215 for the S3 message. By contrast, if CONT frame 213-2 is a trailing portion 235, the answer to inquiry 220_1 is “no” but the answer to inquiry 220_2 is “yes”. As such, the leading content 236 is read from local memory 212 and combined 222 with the newly received trailing content 237. The resultant is the complete CONT frame which is then decompressed and sent 223 to C3.

With respect to FIG. 2f and the processing of the HEADERS frame 213-3 for the S5 message, same/similar processes (224_1, 224_2, 228) as those just described above with respect to FIG. 2d are applied.

With respect to FIG. 2g and the processing of the DATA frame 213-4 for the S3 message, if DATA frame 213-4 is a leading portion 234, the answer to inquiry 231_1 is “yes”. As such the intermediate leading payload content 236 is stored 232 in the meta data 215 for the S3 message. By contrast, if DATA frame 213-4 is a trailing portion 235, the answer to inquiry 231_1 is “no” but the answer to inquiry 231_2 is “yes”. As such, the leading content 236 is read from local memory 212 and combined 233 with the newly received trailing content 237. The resultant is the complete DATA frame which is then sent 234 to C3.

With respect to FIG. 2h and the processing of the DATA frame 213-5 for the S5 message, same/similar processes (236_1, 236_2, 237, 238) as those just described above with respect to FIG. 2g are applied.

In a more complex scenarios, a message's payload as carried by the respective payload of one or more DATA frames is compressed or encoded in some other way (e.g., encrypted). If so, the message's header information (and subsequently its meta data) can identify the type of encoding so that the HTTP/2 instance understands what type of decompression, decoding, etc. is to be applied to the message's payload.

In the case of encryption, the type of encryption could be left out of the message header (so as not to assist any unwelcome message listeners). Here, for instance, the type of encryption to be applied can be established as part of the setup of the connection and then stored locally on the receiving side. In this case, there is a default type of encryption for the connection and the HTTP/2 layer need not discover it in the header of a received message. As such, the message header need only indicate whether the message payload is encrypted and, if so, the HTTP/2 instance records that decryption is required in the message's meta data so that it is applied with the message's DATA frames are received.

Importantly, processes 218, 223, 229, 234, 239 send newly received frame content to their destination. As such, queueing of all frames belonging to a same in-flight HTTP/2 message in memory that is local to the HTTP/2 instance is avoided as evidenced by the rapid decrease of stored frames in memory 212 from FIG. 2a through FIG. 2h. However, e.g., to reduce communication overhead between the platform that supports the HTTP/2 instance and the receiving endpoint, frames that have been processed by the HTTP/2 instance and are destined for a same endpoint and/or same hardware destination (where multiple endpoints are supported) can be queued in memory that is local to the HTTP/2 instance. Once the total number and/or size of such frames reaches a particular threshold, they are packed together into the payload of a same packet and sent to the endpoint/network address.

Although the example of FIGS. 2a through 2h pertained to response messages that were being sent to a client device, the same processes described above with respect to FIGS. 2a through 2h can likewise be applied to request messages (or other messages) that are being sent to services (e.g., services S1-S5 of FIG. 1a) within a data center.

In various embodiments, the meta data described above for the processes of FIGS. 2a through 2h are identified not only by a particular stream but also by the particular connection that the particular stream belongs to. In this way, meta data for same stream numbers across multiple connections will not be confused with one another.

Although embodiments above have stressed TCP as the transport layer protocol, it is conceivable that the teachings above could be applied at two different, e.g., IP address, network endpoints where another protocol, such as User Data Protocol (UDP), is used at the transport layer. For example, certain implementations can use the QUIC protocol between UDP and a text transfer protocol (e.g., HTTP/2, HTTP/3, etc.) that employs the message receiving teachings provided at length above. Here, UDP with QUIC (“UDP+QUIC”) provide a connection based transport layer protocol.

The HTTP/2 protocol is specified in RFC 7540, “Hypertext Transfer Protocol 2 (HTTP/2)” published by the HTTP Working Group of the Internet Engineering Task Force (IETF). Although the teachings above have been focused on HTTP/2 teachings specifically, it is important to point that the teachings above can be applied to other text/document/file transportation protocols (to the extent they sends messages in frames and/or multiplex the respective frames of multiple in-flight messages) besides HTTP/2 such as, future generations of the Hypertext Transfer Protocol (HTTP) beyond HTTP/2 (e.g., HTTP/3), other versions of HTTP and/or their future generations (e.g., HTTP Secure (HTTPS), current and/or future versions of Post Office Protocol (POP), Simple Mail Transfer Protocol (SMTP), Network News Transfer Protocol (NNTP), File Transfer Protocol (FTP), Network Time Protocol (NTP), etc.

The teachings above are believed to be particularly useful in a data center environment, or other complex computing environment, that relies upon one or more infrastructure processing units (IPUs) to offload underlying networking functions, such as the TCP and HTTP/2 protocols, from the processors that execute the service endpoints (e.g., S1-S5 in FIG. 1a). More details are provided immediately below.

FIG. 3 shows a new, emerging data center environment in which “infrastructure” tasks are offloaded from traditional general purpose “host” CPUs (where application software programs are executed) to an infrastructure processing unit (IPU), data processing unit (DPU) or smart networking interface controller (SmartNIC), any/all of which are hereafter referred to as an IPU.

Networked based computer services, such as those provided by cloud services and/or large enterprise data centers, commonly execute application software programs for remote clients. Here, the application software programs typically execute a specific (e.g., “business”) end-function (e.g., customer servicing, purchasing, supply-chain management, email, etc.). Remote clients invoke/use these applications through temporary network sessions/connections that are established by the data center between the clients and the applications. A recent trend is to strip down the functionality of at least some of the applications into more finer grained, atomic functions (“microservices”) that are called by client programs as needed. Microservices typically strive to charge the client/customers based on their actual usage (function call invocations) of a microservice application. Microservice function calls and associated operands can be formatted according to various syntaxes and/or protocols such as Remote Procedure Call (RPC), gRPC, Cap'n Proto, Apache Thrift, Apache Avro, JSON-RPC, XML-RPC, etc.

In order to support the network sessions and/or the applications' functionality, however, certain underlying computationally intensive and/or trafficking intensive functions (“infrastructure” functions) are performed.

Examples of infrastructure functions include transport layer protocol functions (e.g., TCP), hypertext transfer communication protocol functions (such as HTTP/2), encryption/decryption for secure network connections, compression/decompression for smaller footprint data storage and/or network communications, virtual networking between clients and applications and/or between applications, packet processing, ingress/egress queuing of the networking traffic between clients and applications and/or between applications, ingress/egress queueing of the command/response traffic between the applications and mass storage devices, error checking (including checksum calculations to ensure data integrity), distributed computing remote memory access functions, etc.

Traditionally, these infrastructure functions have been performed by the CPU units “beneath” their end-function applications. However, the intensity of the infrastructure functions has begun to affect the ability of the CPUs to perform their end-function applications in a timely manner relative to the expectations of the clients, and/or, perform their end-functions in a power efficient manner relative to the expectations of data center operators.

As such, as observed in FIG. 3, the infrastructure functions are being migrated to an infrastructure processing unit. FIG. 3 depicts an exemplary data center environment 300 that integrates IPUs 307 to offload infrastructure functions from the host CPUs 304 as described above.

As observed in FIG. 3, the exemplary data center environment 300 includes pools 301 of CPU units that execute the end-function application software programs 305 that are typically invoked by remotely calling clients. The data center also includes separate memory pools 302 and mass storage pools 303 to assist the executing applications. The CPU, memory storage and mass storage pools 301, 302, 303 are respectively coupled by one or more networks 304.

Notably, each pool 301, 302, 303 has an IPU 307_1, 307_2, 307_3 on its front end or network side. Here, each IPU 307 performs pre-configured infrastructure functions on the inbound (request) packets it receives from the network 304 before delivering the requests to its respective pool's end function (e.g., executing software in the case of the CPU pool 301, memory in the case of memory pool 302 and storage in the case of mass storage pool 303). As the end functions send certain communications into the network 304, the IPU 307 performs pre-configured infrastructure functions on the outbound communications before transmitting them into the network 304. The communication 312 between the IPU 307_1 and the CPUs in the CPU pool 301 can transpire through a network (e.g., a multi-nodal hop Ethernet network) and/or more direct channels such as Compute Express Link (CXL), Advanced Extensible Interface (AXI), Open Coherent Accelerator Processor Interface (OpenCAPI), Gen-Z, etc.

Depending on implementation, one or more CPU pools 301, memory pools 302, mass storage pools 303 and network 304 can exist within a single chassis, e.g., as a traditional rack mounted computing system (e.g., server computer). In a disaggregated computing system implementation, one or more CPU pools 301, memory pools 302, and mass storage pools 303 are separate rack mountable units (e.g., rack mountable CPU units, rack mountable memory units (M), rack mountable mass storage units (S)).

In various embodiments, the software platform on which the applications 305 are executed include a virtual machine monitor (VMM), or hypervisor, that instantiates multiple virtual machines (VMs). Operating system (OS) instances respectively execute on the VMs and the applications execute on the OS instances. Alternatively or combined, container engines (e.g., Kubernetes container engines) respectively execute on the OS instances. The container engines provide virtualized OS instances and containers respectively execute on the virtualized OS instances. The containers provide isolated execution environment for a suite of applications which can include applications for microservices.

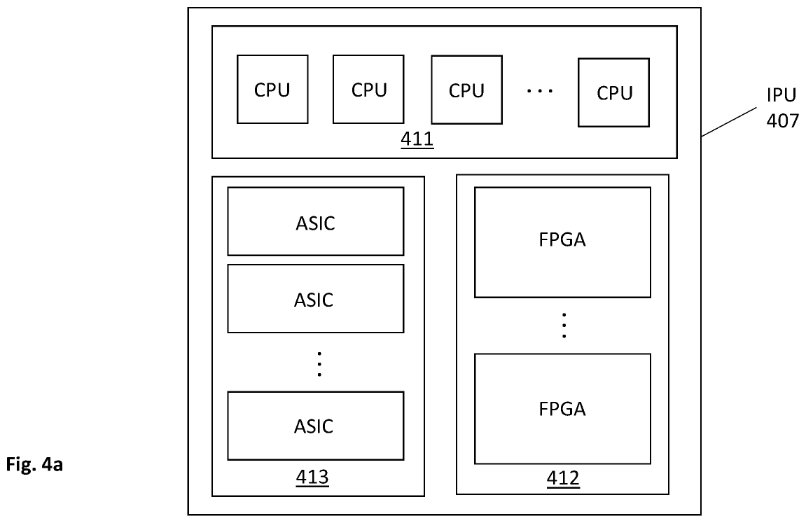

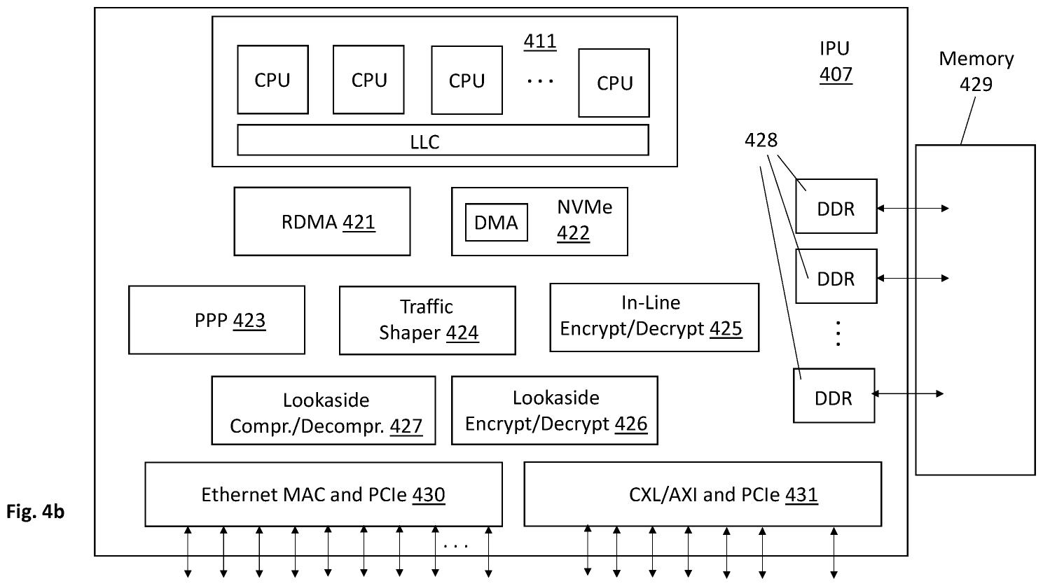

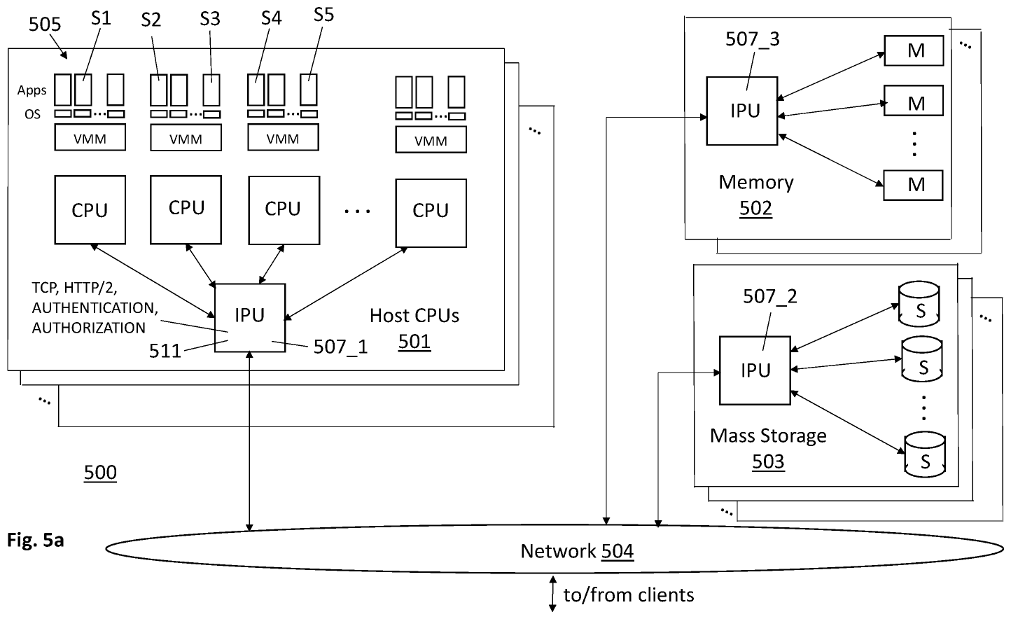

Comparing FIG. 1a and FIG. 3, endpoints S1-S5 of FIG. 1a can be implemented as different, e.g., microservice applications/end-functions S1-S5 in FIG. 3. Here, the microservice end-functions/applications S1-S5 are observed in FIG. 3 as executing within their own respective container environments on respective CPUs. Also, as observed in FIG. 3, the TCP and HTTP/2 instances 311 as described above in detail with respect to FIGS. 1a, 1b, and 2a through 2h are implemented on an IPU 307_1 within a CPU pool 301. As implemented on the IPU 307_1, as discussed more thoroughly below with respect to FIGS. 4a and 4b, the TCP and/or HTTP/2 instances can be implemented as software that executes on at least one embedded processor within an IPU 307_1, programmable hardware (e.g., FPGA) within an IPU 307_1, dedicated hardwire circuitry (ASIC) within an IPU 307_1, or any combination of these.

As such, for inbound HTTP/2 messages, an IPU 307_1 sends individual frames that belong to a same inbound message piecemeal to a targeted microservice (e.g., any of S1-S5), or, e.g., packs frames that the IPU 307_1 has processed and are destined for a same CPU into a same packet that is sent to the CPU. Importantly, this reduces the amount of local IPU memory (memory 429 as described further below with respect to FIG. 4b) because buffering of all frames, e.g., for all in-flight messages that are transported over a same TCP connection, within the local IPU memory is avoided. Frames that belong to a same HTTP/2 message are reassembled at the CPU that implements the microservice that the HTTP/2 message is targeted to.

FIG. 4a shows an exemplary IPU 407. As observed in FIG. 4 the IPU 407 includes a plurality of general purpose processing cores 411, one or more field programmable gate arrays (FPGAs) 412, and/or, one or more acceleration hardware (ASIC) blocks 413. An IPU typically has at least one associated machine readable medium to store software that is to execute on the processing cores 411 and firmware to program the FPGAs (if present) so that the processing cores 411 and FPGAs 412 (if present) can perform their intended functions.

The IPU 407 can be implemented with: 1) e.g., a single silicon chip that integrates any/all of cores 411, FPGAs 412, ASIC blocks 413 on the same chip; 2) a single silicon chip package that integrates any/all of cores 411, FPGAs 412, ASIC blocks 413 on more than chip within the chip package; and/or, 3) e.g., a rack mountable system having multiple semiconductor chip packages mounted on a printed circuit board (PCB) where any/all of cores 411, FPGAs 412, ASIC blocks 413 are integrated on the respective semiconductor chips within the multiple chip packages.

The processing cores 411, FPGAs 412 and ASIC blocks 413 represent different tradeoffs between versatility/programmability, computational performance and power consumption. Generally, a task can be performed faster in an ASIC block and with minimal power consumption, however, an ASIC block is a fixed function unit that can only perform the functions its electronic circuitry has been specifically designed to perform.

The general purpose processing cores 411, by contrast, will perform their tasks slower and with more power consumption but can be programmed to perform a wide variety of different functions (via the execution of software programs). The general purpose processing cores can be implemented as reduced instruction set (RISC) processors, complex instruction set (CISC) processors, a combination of RISC and CISC processors, etc.

The FPGA(s) 412 provide for more programming capability than an ASIC block but less programming capability than the general purpose cores 411, while, at the same time, providing for more processing performance capability than the general purpose cores 411 but less than processing performing capability than an ASIC block.

FIG. 4b shows a more specific embodiment of an IPU 407. The particular IPU 407 of FIG. 4b does not include any FPGA blocks. As observed in FIG. 4b the IPU 407 includes a plurality of general purpose cores (e.g., RISC) 411 and a last level caching layer for the general purpose cores 411. The IPU 407 also includes a number of hardware ASIC acceleration blocks including: 1) an RDMA acceleration ASIC block 421 that performs RDMA protocol operations in hardware; 2) an NVMe acceleration ASIC block 422 that performs NVMe protocol operations in hardware; 3) a packet processing pipeline ASIC block 423 that parses ingress packet header content, e.g., to assign flows to the ingress packets, perform network address translation, etc.; 4) a traffic shaper 424 to assign ingress packets to appropriate queues for subsequent processing by the IPU 407; 5) an in-line cryptographic ASIC block 425 that performs decryption on ingress packets and encryption on egress packets; 6) a lookaside cryptographic ASIC block 426 that performs encryption/decryption on blocks of data, e.g., as requested by a host CPU 301; 7) a lookaside compression ASIC block 427 that performs compression/decompression on blocks of data, e.g., as requested by a host CPU 301; 8) checksum/cyclic-redundancy-check (CRC) calculations (e.g., for NVMe/TCP data digests and/or NVMe DIF/DIX data integrity); 9) thread local storage (TLS) processes; etc.

The IPU 407 also includes multiple memory channel interfaces 428 to couple to external memory 429 that is used to store instructions for the general purpose cores 411 and input/output data for the IPU cores 411 and each of the ASIC blocks 421-426. The IPU includes multiple PCIe physical interfaces and an Ethernet Media Access Control block 430, and/or more direct channel interfaces (e.g., CXL and or AXI over PCIe) 431, to support communication to/from the IPU 407. Here, for example, interfaces 430 can be viewed as one or more network side interfaces because these interfaces 430 interface with network 304 in FIG. 3. By contrast, interfaces 431 correspond to host side interfaces because these interfaces 431 interface with the deeper functional components of the IPU's associated pool, e.g., CPUs in the case of IPU 307_1, mass storage devices in the case if IPU 307_2, memory devices in the case of IPU 307_2 and accelerators in the case of an IPU within an accelerator pool (not shown). The IPU 407 can also include DMA functionality, whether implemented in program code that executes on the IPU's processing cores 411, FPGA form, ASIC form, or any combination of these to forward information from the IPU to, e.g., the local memories of the CPUs of a CPU pool, the local memories of the accelerators of an accelerator pool, etc.

As mentioned above, the IPU 407 can be a semiconductor chip, a plurality of semiconductor chips integrated within a same chip package, a plurality of semiconductor chips integrated in multiple chip packages that components of a module or card (e.g., a NIC), etc.

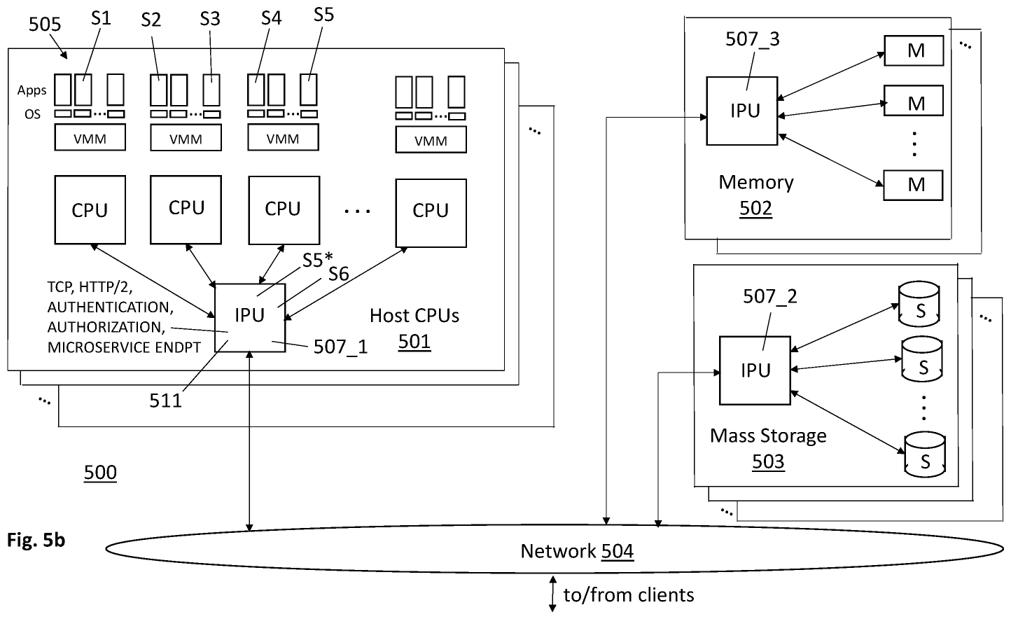

FIG. 5a shows that additional functions 511 can be performed at the IPU 507_1 commensurate/concurrently with HTTP/2 message processing (or other text transfer protocol message processing) in conjunction with the processes described above with respect to FIGS. 2d through 2h. Specifically, either or both of authorization and authentication can be performed with enhanced meta data stored, e.g., in the local memory of the IPU 507_1. In the case of authorization, commonly, a hash value is computed from the received message content (and a public key maintained at the receiving end, in this case, the IPU 507_1). If the computed hash value does not match a hash value that was included in the message, the message is flagged as having been tampered with. Here, the hash value is computed in sequence with the message content as it arrives (e.g., an XOR function that receives as input the inbound information as it arrives). As such, it is not necessary to store the entire message content (or message payload content) locally to the IPU 507_1 in order to calculate the hash value (it can be calculated with each new arriving frame, leading portion and trailing portion). Thus, by calculating the hash value with the content of a new frame for a same message, storing the resultant in message meta data and then using the resultant in combination with the content of a next new frame for the message and repeating, when the final frame has been received for the message, the final hash value for the message can be calculated.

In the case of authorization, the IPU 507_1 determines whether or not a sending entity (e.g., any of C1-05 in FIG. 1a) is authorized to send communications to an endpoint (e.g., any of S1-S5). Here, the IPU 507_1 maintains within its local memory (or fetches from remote storage) a list of its associated destination endpoints (e.g., S1-S5) and a binding between each of these endpoints and the source endpoints that are allowed to access the destination endpoints. Thus, consistent with the example of FIG. 1a, C1 would be bound with S1, C2 would be bound with S2, etc. During processing of the inbound frames for any particular message, when the sending and target endpoints are identified in the processed message content (e.g., message header content found within a HEADERS frame or CONT frame), the IPU 507_1 can refer to its local authorization information to see if the source endpoint has permission to access the target endpoint.

FIG. 5c elaborates further on message processing at the IPU 507_1 concurrent with HTTP/2 processing (or other text transfer protocol processing). Here, as observed in FIG. 5c, IPU 507_1 is capable of performing end-point microservices S5* and S6. Thus, IPU 507_1 can, e.g., understand and execute a microservice function call embedded within a message whose underlying frames are also processed by the IPU 507_1. For example, when processing the message's frames according to the HTTP/2 protocol, the IPU 507_1 processes the frame's substantive content to recognize a microservice function call. The IPU 507_1 can store information relating to its comprehension of the message content in the meta data that the IPU 507_1 maintains for the message as described above at length with respect to FIGS. 2a through 2i (e.g., the IPU 507_1 can, as the sequence of the message's frames are received, build within the meta data (and then eventually recognize) the message's microservice function call's opcode and operand).

Here, S5* corresponds to a first mode in which the IPU 507_1 is configured to offload the CPU that is supporting microservice S5 for, e.g., certain functions. For example, if a function call is made to microservice S5 to decompress a data item identified within the function call by an address in the memory pool 502, the IPU 507_1, having a decompression ASIC block (e.g., block 427), can intercept the message, retrieve the data item and decompress the data item on behalf of microservice S5 (the CPU that supports microservice S5 did not execute the function call).

Here, some updating of communication state from the IPU 507_1 to microservice S5 may be necessary so that microservice S5 understands that the IPU 507_1 intercepted and performed a function call on its behalf (e.g., if microservice S5 is to perform the next process after the function performed by the IPU 507_1). Depending on the semantics associated with the function call, the IPU 507_1 can respond to the calling customer (C5), and/or, invoke another next microservice function that is appropriate for the calling customer's microserviced process flow.

In another mode of operation, the IPU 507_1 is the endpoint for a microservice S6 rather than one of the CPUs within the CPU pool 501. Here, for example, the software to fully implement microservice S6 executes on one or more of the general purpose processing cores of the IPU 507_1. The S6 microservice can be, e.g., similar to any of microservices S1-S5 in that all the microservices S1-S6 receive function calls from certain users to perform certain functions, and such functional calls are performed/resolved with the corresponding underlying hardware (CPUs for microservices S1-S5 and IPU for microservice S6). This can include not only substantive processing of data, but also, depending on the associated semantics, responding to a calling customer, and/or, invoking another next microservice function that is appropriate for a larger microserviced process flow.

In various embodiments, as suggested above, a motivation for implementing partial or full microservice support at an IPU is the presence of the acceleration hardware on the IPU (e.g., ASIC, FPGA). For example, referring briefly back to FIG. 4b, any of ASIC blocks 425, 426 and 427 can be repurposed to provide microservices directly rather than in-line or lookaside infrastructure tasks.

Candidate microservices and/or microservice endpoint function calls that can be performed at an IPU include, to name a few: 1) compression/decompression (e.g., with compression/decompression ASIC, FPGA and/or software functionality integrated with the IPU); 2) artificial intelligence (AI) inferencing (e.g., with neural network ASIC, FPGA and/or software functionality integrated with the IPU); 3) video transcoding (e.g., with video transcoding ASIC, FPGA and/or software functionality integrated with the IPU); 4) video annotation (e.g., with video annotation ASIC, FPGA and/or software functionality integrated with the IPU); 5) encryption/decryption (e.g., with video annotation ASIC, FPGA and/or software functionality integrated with the IPU); 6) intrusion detection (e.g., with security ASIC, FPGA and/or software functionality integrated with the IPU); etc.

Embodiments of the invention may include various processes as set forth above. The processes may be embodied in program code (e.g., machine-executable instructions). The program code, when processed, causes a general-purpose or special-purpose processor to perform the program code's processes. Alternatively, these processes may be performed by specific/custom hardware components that contain hard wired interconnected logic circuitry (e.g., application specific integrated circuit (ASIC) logic circuitry) or programmable logic circuitry (e.g., field programmable gate array (FPGA) logic circuitry, programmable logic device (PLD) logic circuitry) for performing the processes, or by any combination of program code and logic circuitry.

Elements of the present invention may also be provided as a machine-readable medium for storing the program code. The machine-readable medium can include, but is not limited to, floppy diskettes, optical disks, CD-ROMs, and magneto-optical disks, FLASH memory, ROMs, RAMs, EPROMs, EEPROMs, magnetic or optical cards or other type of media/machine-readable medium suitable for storing electronic instructions.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. An apparatus, comprising:
a host side interface to couple to one or more central processing units (CPUs) that support multiple microservice endpoints;
a network interface to receive from a network a packet having multiple frames that belong to different streams, the multiple frames formatted according to a text transfer protocol;
circuitry to:
process the frames according to the text transfer protocol and build content of a microservice functional call embedded within a message that one of the frames transports; and,
execute the microservice function call.

2. The apparatus of claim 1 wherein the microservice function call is executable on behalf of one of the multiple microservice endpoints.

3. The apparatus of claim 1 wherein the microservice functional call targets a microservice endpoint that is implemented on the IPU.

4. The apparatus of claim 1 further comprising ASIC and/or FPGA functionality to execute the microservice function call.

5. The apparatus of claim 4 wherein the ASIC and/or FPGA functionality comprises any one or more functionalities from the following list functionalities:
compression;
decompression;
artificial intelligence inferencing;
video transcoding;
video annotation;
encryption;
decryption; and/or,
security.

6. The apparatus of claim 1 wherein the host side interface is to send a second message that was transported by another of the frames to a respective one of the multiple microservice endpoints.

7. The apparatus of claim 1 wherein the text transfer protocol is HTTP/2.

8. A data center, comprising:
a CPU pool that supports a plurality of microservice endpoints;
a memory pool;
an accelerator pool;
a network that couples the CPU pool, the memory pool and the accelerator pool; and,
an infrastructure processing unit (IPU) coupled between the CPU pool and the network, the IPU configured to execute program code that when processed by the IPU causes the IPU to perform a method, comprising:
receiving a packet from the network having multiple frames that belong to different streams, the multiple frames formatted according to a text transfer protocol;
processing the frames according to the text transfer protocol, the processing including building content of a microservice functional call embedded within a message that one of the frames transports; and,
executing the microservice function call.

9. The data center of claim 8 wherein the microservice function call is executed on behalf of one of the plurality of microservice endpoints.

10. The data center of claim 8 wherein the microservice functional call targets a microservice endpoint that is implemented on the IPU.

11. The data center of claim 8 wherein the executing of the microservice function call invokes ASIC and/or FPGA functionality of the IPU.

12. The data center of claim 11 wherein the ASIC and/or FPGA functionality comprises any one or more functionalities from the following list functionalities:
compression;
decompression;
artificial intelligence inferencing;
video transcoding;
video annotation;
encryption;
decryption; and/or,
security.

13. The data center of claim 8 wherein the method further comprises sending a second message that was transported by another of the frames to a respective one of the multiple microservice endpoints.

14. The data center of claim 8 wherein the text transfer protocol is HTTP/2.

15. A machine readable storage medium containing program code that, when processed by an infrastructure processor unit (IPU) that is coupled between one or more central processing units (CPUs) that support multiple microservice endpoints and one or more clients that act as microservice customers, causes a method to be performed, the method comprising:
receiving a packet having multiple frames that belong to different streams, the multiple frames formatted according to a text transfer protocol;
processing the frames according to the text transfer protocol, the processing including building content of a microservice functional call embedded within a message that one of the frames transports; and,
executing the microservice function call.

16. The machine readable storage medium of claim 15 wherein the microservice function call is executed on behalf of one of the multiple microservice endpoints.

17. The machine readable storage medium of claim 15 wherein the microservice functional call targets a microservice endpoint that is implemented on the IPU.

18. The machine readable storage medium of claim 15 wherein the executing of the microservice function call invokes ASIC and/or FPGA functionality of the IPU.

19. The machine readable storage medium of claim 18 wherein the ASIC and/or FPGA functionality comprises any one or more functionalities from the following list functionalities:
compression;
decompression;
artificial intelligence inferencing;
video transcoding;
video annotation;
encryption;
decryption; and/or,
security.

20. The method of claim 15 wherein the method further comprises sending a second message that was transported by another of the frames to a respective one of the multiple microservice endpoints.
